(19) United States
(12) Patent Application Publication
(10) Pub. No.: US 2024/0221531 A1
(43) Pub. Date: Jul. 4, 2024

(54) INTERACTIVE GAMEBOOK WITH REARRANGEABLE PAGES

(71) Applicant: WOODPECKER LABORATORIES, LLC, Nyack, NY (US)

(72) Inventor: Zachary ROME, Nyack, NY (US)

(21) Appl. No.: 18/549,059

(22) PCT Filed: Feb. 21, 2022
(86) PCT No.: PCT/US2022/070751

§ 371 Date: Sep. 5, 2023

Related U.S. Application Data
(60) Provisional application No. 63/162,377, filed on Mar. 17, 2021.

(51) Int. Cl. G09B 17/00

(52) U.S. Cl. CPC G09B 17/003

(57) ABSTRACT

Articles and methods as described herein include an interactive books or game assemblies that can be rearranged or reorganized while retaining cohesion. The articles can include a first page and a last page, wherein a first page is arranged at the beginning of a sequence, and a last page arranged at the end of a sequence, at least one story page following the first page, and before the last page. The at least one story page ends with a preposition or verb to allow the story pages to be organized and rearranged.

### CROSS REFERENCE TO RELATED APPLICATION

This application is a National Stage Application of PCT/US2022/070751, filed on Mar. 7, 2022, which claims the benefit of U.S. Provisional Patent No. 63/162,377, filed on Mar. 17, 2021, the disclosures of which are incorporated herein by reference in their entireties. To the extent appropriate, a claim of priority is made to each of the above disclosed applications.

### TECHNICAL FIELD

Embodiments relate generally to manually or digitally operated educational appliances, books, games, and puzzles for children. More particularly, embodiments relate to books or stories, or gamebooks with symbols, characters, or pictures that may be arranged or adapted to be arranged in one or more particular ways to create variety and interest without losing coherence or becoming nonsensical.

### BACKGROUND

Reading, or learning to read, is an important milestone in the development of any child or adult. However, various means have been used to attempt to make reading more accessible, interesting, and interactive for children, or those learning to read. Interactive reading has been shown to increase reading comprehension, memory retention, and general interest. Generally, children's books are bound, with several sequential pages depicting text and illustrations. The books are read from front to back to create a storyline and arranged in a chronological order to progress in a meaningful way.

Other books may include pockets or inserts with objects to touch, hold, or play with. These books seek to engage a young reader by attaching meaning to new words. Additionally, these books provide entertainment to the child or reader. Books with removable objects may help with sensory learning, especially if they are made out of different materials, or textures. The objects may be puppets, toys, shapes, or other eye-catching and removable features. Sometimes, simply reading the words off a page is not enough to allow a child to completely grasp the written material.

Like books with pockets, pop-up books have gained popularity. The pages of pop-up books open into three-dimensional illustrations that may have moving parts or pieces. These books may help bring words and objects to life by showing the child what they look like in real life and creating another layer of complexity with moveable features. However, pop-up books may be limited in the number of stories that can be created, given the task of illustrating the words via the pop-up.

The stories within each of these books may become repetitive. Even with the added features to engage a child's attention and interaction, reading the same sequence of words may become mundane, and eventually, the child will may no longer engage with the book. Some books have tried to remedy this feature by leaving space to write in words, or verbally fill in the blank. While this attempt may provide some amount of added versatility, it still requires that a child or reader know how to say or spell the word, which limits how useful or helpful the feature may be.

There exists a need for an interactive book or game that maintains a reader or user's interest without becoming familiar, and makes reading enjoyable for a child, adult, or other reader.

### SUMMARY

Embodiments of the present disclosure relate to an interactive storybook or gamebook or puzzle that can be shuffled, jumbled, or rearranged to allow for numerous stories from the same set of pages or pieces. The interactive storybook or gamebook may have a set first page and a set last page. The first and last page are placed on each end of a sequence of story pages to allow for a grammatically cohesive storyline. The story pages that comprise the substance of the story may be placed in any order the user chooses between the set first and last pages, and rearranged or moved as chosen. In leaving the first page at the beginning of the story, and the last page as the conclusion, any sequence of storybook pages will read as a comprehensible and coherent story no matter how the story pages are arranged.

The first page of the storybook or gamebook may carry indicia in the form of a noun or the subject of the story, as well as an illustration or other symbolic representation relating to a main theme being addressed on the first page. Each story page that follows may have text printed thereon, optionally accompanied by an illustration of a character or other symbolic representation which matches the meaning of the text printed on the page. In some embodiments, the story pages each begin with an indefinite article, followed by a noun. In other embodiments, the story pages may begin with a noun itself if no indefinite article is required. In certain embodiments, after the noun, the story pages may be followed by a verb. Such a verb may be preceded by or followed by a preposition. In some embodiments, a preposition or verb will follow the noun. In further embodiments, the story pages will end with a preposition or verb. The story pages do not end in a part of speech that would cause a complete sentence. In further embodiments, the first page can also include the text of a story page, such that it ends with a preposition or verb. In some embodiments, the last page ends with a direct object or other form of noun.

In other embodiments, the storybook or gamebook of the disclosed invention is digital or experienced through a computer or similar device. In such embodiments, the pages, illustrations, text, or other symbolic representations of the storybook or gamebooks are read and experienced digitally. The reader or user can shuffle or rearrange the pages by a click of a button or by independently arranging them as they desire. In some embodiments, the computer may read the stories out loud to the user. In further embodiments, an animation can be created and displayed to act out the storyline that the user creates.

In a digital embodiment, the pages may embody other digital manifestations of the physical pages. Further embodiments may represent pages by characters, cards, or other illustrations and symbols. In other embodiments, the digital pages still provide meaningful information to contribute to the storyline, but may be depicted differently than the physical set of pages as illustrated in the figures.

In other embodiments, the storybook or gamebook may be in the form of a puzzle. The pages may have interchangeable puzzle cuts with connecting male and female ends, to physically connect and create a variety of storylines. The puzzle pages of the storybook or gamebook can be connected to form any number of shapes and designs. For example, in some embodiments, the puzzle pages may be connected in one long row and read from left to right, a square or rectangle with multiple rows, or any other arrangement chosen. The puzzle pages may have a first page and a last page that may be placed at the beginning of a storyline, and conclusion of a storyline, respectively.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a story page.

FIG. 2 is a perspective view of a first page.

FIG. 3 is a perspective view of a last page.

FIG. 4 is a perspective view of a first page, an assembly of story pages, and a receptacle.

FIG. 5 is a perspective view of a first page and a selection of story pages.

FIG. 6 depicts an example of a puzzle-piece based assembly of pages, according to another embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

According to the embodiments described herein, the present disclosure relates to an interactive book or game or puzzle with pages that may be shuffled, reorganized, or jumbled. The pages, no matter how they are shuffled or rearranged, will still depict a coherent storyline that has been customized by the reader or user. The purposeful rearrangement of the story pages enables the formation of a desired story. This function is achieved by the use of parts of speech, and the placement of those parts of speech. Because the pages may be shuffled or rearranged, the user is essentially reading a new story each time a page is moved to another location in the sequence.

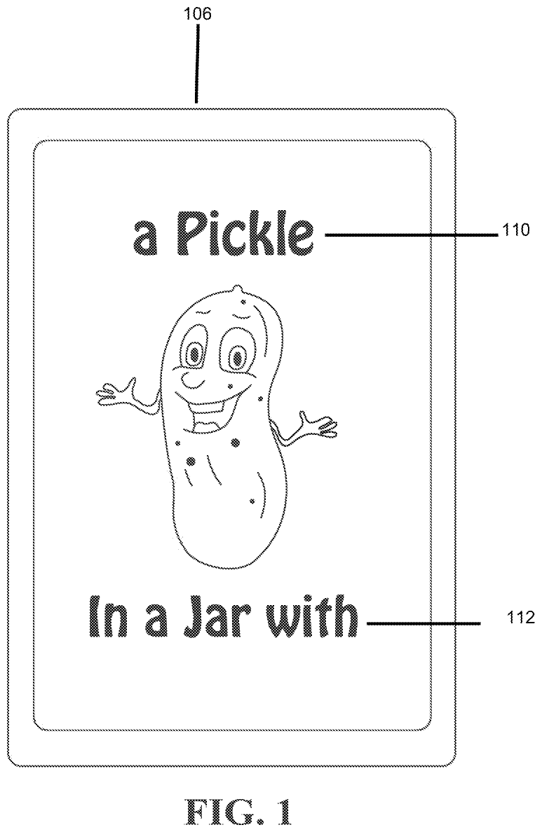

In one embodiment, FIGS. 1-3 illustrate three types of pages that may be used in a storybook assembly 100. FIG. 1 illustrates a story page 106, wherein the page comprises text 110, and an illustration 112 that provides meaning for the text 110. The story page 106 may include or begin with any combination of an indefinite article and a noun. For example, the text 110 on FIG. 1 reads, “a pickle in a jar with.” The indefinite article is followed by a noun, and the text 110 ends with a preposition that enables the combination of the noun and/or pronoun to form a phrase with the next story page. Here, the first and last elements of the text 110, a noun with a preposition, facilitate the combination of the pages in any order because continued repetition of those parts of speech will always form a coherent sentence in the English language.

In one embodiment, the first page 102 illustrates the noun “Ralph,” naming the character or subject in that particular story sequence. The first page 102 may be replaced with text or other indicia that introduces any suitable noun or subject for a particular theme or storyline. The story pages 106 then may include any combination of text 110 that includes related nouns and indefinite articles to characterize the nouns. The story pages 106 end with a preposition or verb that leads into the noun in the first line of the next story page 106. In the same embodiment, the last page 104 illustrates a direct object in the form of the pronoun, “you,” to end the storyline for the reader.

In another embodiment, the first page 102 may have any noun or subject that relates to the title or theme of that particular story. Further, the last page 104 may have any direct object or other form of noun that fits that theme, or another chosen theme. In some embodiments, the first page 102, story pages 106, and last page 104 may each include text that includes whole and grammatically correct sentences. The pages for the first page 102, story pages 106, and last page 104 may be made from paper, cloth, or any other suitable material for printing text 110 and illustrations 112 on. In other embodiments, the pages for the first page 102, story pages 106, and last page 104 may be digital. In a digital embodiment, the first page 102, story pages 106, and last page 104 may embody other digital manifestations of the physical pages. Further embodiments may represent pages by characters, cards, or other illustrations 112 and symbols. In other embodiments, the digital pages still provide meaningful information to contribute to the storyline but may be depicted differently than the physical set of pages as illustrated in FIGS. 1-5. In yet another embodiment, the pages may have apertures on a single side of the page to allow any configuration of the pages to be bound and read in that order. The pages illustrated in FIGS. 1-5 merely illustrate one embodiment of the present disclosure.

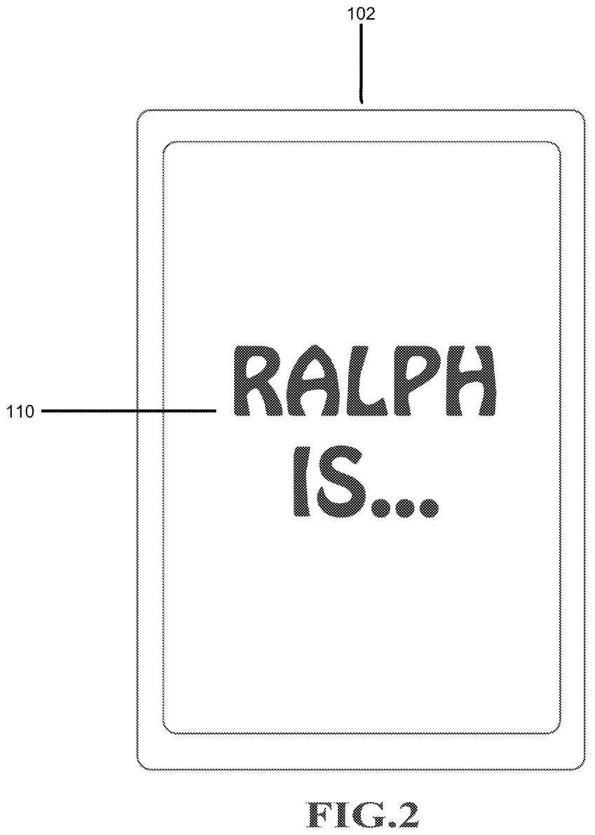

FIG. 2 illustrates a first page 102, wherein the text 110 displayed on the page is a noun to begin the story. The first page 102 may also have an illustration 112 that provides meaning for the text 110 on the first page 102. The text 110 and the illustration 112 on the first page 102, may be any noun with an associated illustration. The first page 102 as illustrated in FIG. 2 may be changed to better describe another story. In yet another embodiment, the pages may have a magnetic edge that corresponds to a magnetic section of a book to allow for any configuration of the pages to be inserted into the magnetic book and be bound and read in that order. The selection of text 110 and illustrations 112 is only according to a single embodiment of the storybook assembly 100.

In another embodiment of FIGS. 1-5, a different language may be used for the text 110. In whichever language is used, the parts of speech as depicted by the text 110, may differ based on language use, and differing sentence structure from one language to another. Additionally, the pages of the book, including the first page 102, story pages 106, and last page 104, may be made of materials that allow a user to increase sensory awareness, including but not limited to: silk, felt, cotton, paper, plastic, or another suitable material. The pages of the book, including the first page 102, story pages 106, and last page 104 may also be a plurality of different shapes, including but not limited to: a circle, a square, an oval, a triangle, or any another suitable shape. Further, the pages of the book may have a pop-up or three-dimensional feature to enhance the interactive nature of the page. In other embodiments, the pages of the book, including the first page 102, story pages 106, and last page 104, are digital and different languages may be used for the text 110.

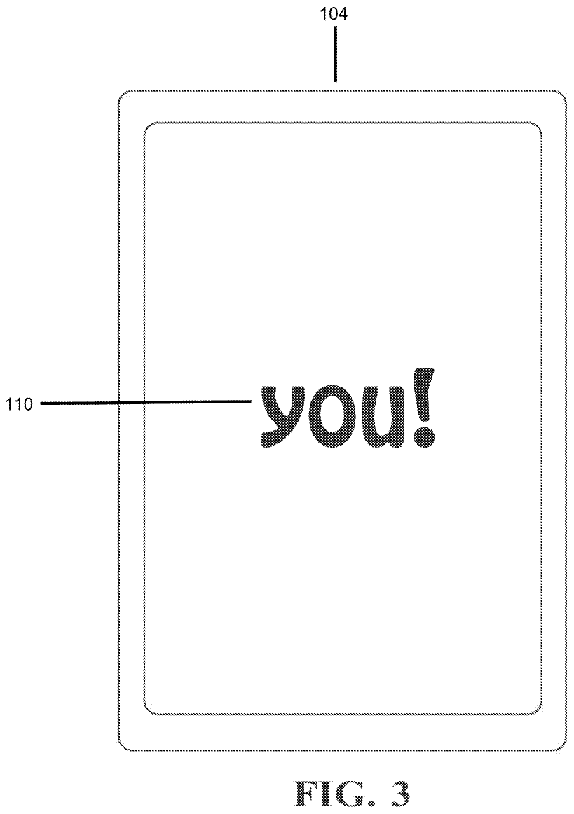

FIG. 3 illustrates a last page 104, wherein the text 110 displayed on the page may be a direct object or other noun. The use of a pronoun, a subset of a direct object as the text 110, enables the user to end the story with themselves. The text 110 displayed in FIG. 3 reads, “you,” but in another embodiment may read any pronoun, direct object, or other form of noun of choice. In some embodiments, the last page 104 may end with a noun or direct object that is preceded by an indefinite article. The last page 104 may also have an illustration 112 associated with the perceived meaning of the pronoun on the last page 104

Embodiments should be understood to define the first page 102 as the start of the story, and the last page 104 as the conclusion of the story. The pages need not to be read from left to right as done in the English language. Further, an embodiment wherein the first page is on the right, and the story is read from right to left may be advantageous for languages other than English.

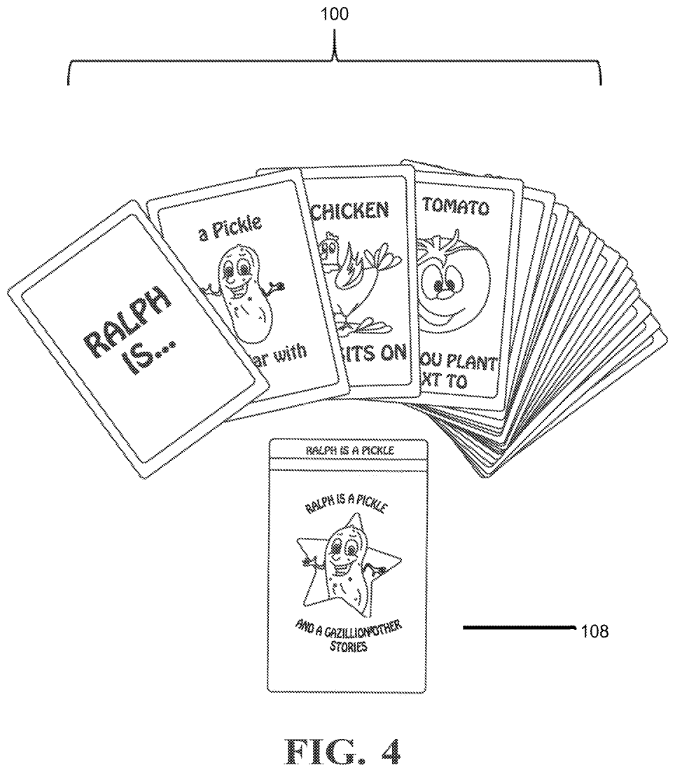

FIG. 4 illustrates the storybook assembly 100. The storybook assembly 100 may comprise a first page 102, any number of story pages 106, and a last page, 104 as seen in FIGS. 1-3. The storybook assembly 100 may also comprise a receptacle 108. The receptacle 108 is a storage device for the pages when they are not in use. The receptacle 108 may be a box or sleeve, and may be paper, plastic, or another suitable material for its use. The receptacle may have text 110 or illustrations 112, as depicted in FIG. 4. The text 100 and illustration 112 may match the theme or general storyline depicted in the story pages 106 within the storybook assembly 100.

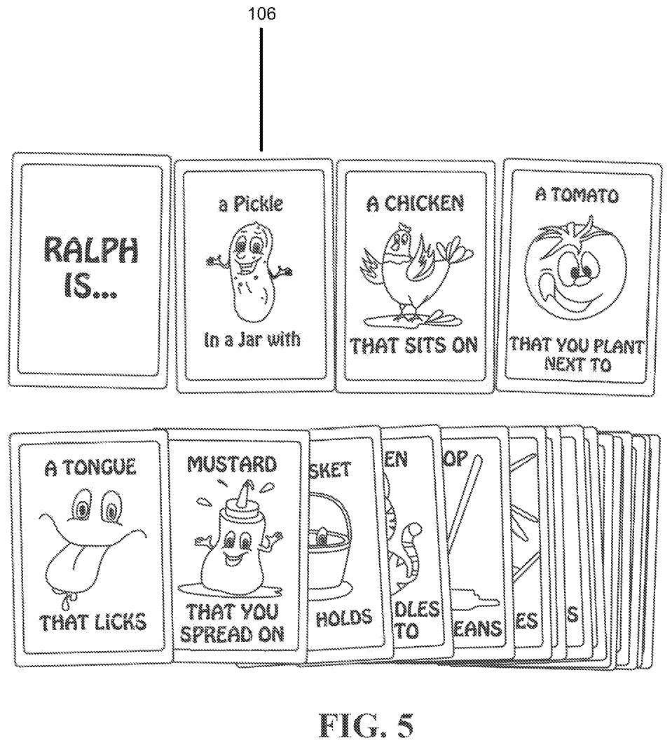

FIG. 5 illustrates, in one embodiment, the storybook assembly 100 in use. The first page 102, is followed by a selected sequence of story pages 106. The selection of story pages 106 is merely for illustrative purposes, and may be arranged or shuffled according to the users desire. FIG. 5 also illustrates that the storybook assembly 100 may have many story pages 106 for the user to select and use in the creation of their story.

The interactive component is the user's ability to rearrange the story pages in any order they choose, with a different and comprehensible story produced with each rearrangement. With the first page at the beginning of the sequence, and the last page concluding the sequence, the story pages can be shuffled, jumbled, or rearranged in any order. The rearrangeable nature of the assembly is possible because of the use of parts of speech, including the noun on the first page, and pronoun or direct object on the last page. The rearrangeability of the storybook is advantageous, because it may enhance a reader's creativity by allowing them to create a story of their choice and moving the pages around to better fit the vision they have for the story. Additionally, the shuffleable nature of the storybook is cost effective and fun, because the assembly is creating numerous stories from a single book.

In assembly, each story book assembly 100 may comprise a first page 102, a series of story pages 106, and a last page, 104. When the pages are not in use, they may be stored in the receptacle 108. A user may lay the sequence of pages out on a surface, or pile them in a stack when creating their own story. The user first selects the first page, 102. Following the first page, the user may select any story page 106 and arrange, rearrange, and shuffle them as they please. Each arrangement of story pages 106 will read in a cohesive manner, creating a new storyline with each arrangement. The organization of the text on each story page 106 facilitates the shuffleability, because each preposition or verb leads into a noun on the next story page 106.

In operation, the storybook assembly 100 may have any number of story pages 106 with text 110 and illustrations 112. The story pages 106 may be arranged in any order selected by a user, and can be stacked, laid on a surface, or held in the user's hand. The user may begin the creation of their story by first selecting the first page 102, and then a sequence of story pages 106, concluding with the last page 104. Leaving the first page 102, and the last page 104 in their respective positions, the user may then continue to rearrange or shuffle the story pages 106 to read as a new story each time. When the user is finished reading the story, the first page 102, story pages 106, and last page 104 may be stored in the receptacle 108 for later use.

In one embodiment, the purpose of the rearrangeability of the story pages 106, is to allow a user to create a new storyline each time they read the book. Because the pages can be shuffled, rearranged, and reorganized, the user may be reading a new book each time they switch the arrangement. The shuffling feature of the storybook assembly 100 is also advantageous in the sense of creativity, because a new reader is able to create the story that they want to read from start to finish.

In another embodiment, the first page 102, last page 104, and story pages 106 may have one or more apertures on a single side of the page. The apertures may allow the user to reversibly bind the pages in a selected sequence if the user so chooses. In another embodiment, the first page 102, last page 104, and/or story pages 106 may have a magnetic edge on at least one side of the page. The magnetic edge could correspond to a book or book cover or other appropriate receptacle with a magnetic section to allow the user to reversibly bind the pages in a selected sequence if the user so chooses. This feature would keep the story in the selected sequence to read again, until the user unbinds the pages and selects a new sequence of story pages 106.

In another embodiment, the pages of the storybook or gamebook may also be puzzle pieces. For example, in some embodiments, they might have interchangeable jigsaw puzzle cuts, as shown in FIG. 6. The cuts of the puzzle pages may have male and female ends that can be physically connected together to form a variety of different storylines. The puzzle pages can be connected to form any number of shapes and designs. For example, in some embodiments, they may be connected in one long row and read left to right, or right to left, with the first “page” or puzzle piece 202, a form of the first page 102, followed by several middle pieces 204, a form of the story pages 106, concluded by the last “page” or puzzle piece 206, a form of the last page 104. The shapes of the puzzle pieces 202, 204, 206 in FIG. 6 are designed such that the top-left piece is the first piece 202, the bottom-right corner piece is the last piece 206, and any number of intermediate pieces 204 can be arranged therebetween, either in one row or in multiple rows. Other shapes and designs of the puzzle include, but are not limited to, circles, ovals, rectangles, diamonds, squiggly lines, non-geometric shapes, and depictions of certain characters, among other possibilities.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. An interactive book or game assembly comprising:
a first page and a last page, wherein a first page is arranged at the beginning of a sequence, and a last page is arranged at the end of a sequence; and
at least one story page following the first page, and before the last page;
wherein the at least one story page ends with a preposition or verb or adverb to allow the story pages to be organized and rearranged.

2. The interactive book or game assembly of claim 1 wherein the first page depicts a noun or subject.

3. The interactive book or game assembly of claim 1 wherein the last page depicts a direct object.

4. The interactive book or game assembly of claim 1 wherein the story page begins with a noun or indefinite article.

5. The interactive book or game assembly of claim 1 wherein the first page ends with a preposition or verb.

6. The interactive book or game assembly of claim 1 wherein the pages feature text.

7. The interactive book or game assembly of claim 1 wherein the pages feature illustrations.

8. The interactive book or game assembly of claim 1 wherein the pages are unbound or temporarily bound.

9. The interactive book or game assembly of claim 1 wherein the pages have apertures or a magnetic edge.

10. The interactive book or game assembly of claim 1 wherein the pages are made of silk, felt, cotton, paper, paperboard, cardboard, plastic, or another material.

11. The interactive book or game assembly of claim 1 wherein the book or game is digital or electronic.

12. The interactive book or game assembly of claim 1 or 11 wherein a sequence created is animated.

13. The interactive book or game assembly of claim 1 or 11 wherein the sequence can be read out loud by an electronic device.

14. The interactive book or game assembly of claim 1 or 11 wherein the pages may be made in the form of a card, a digital page, an animation, or character or sort.

15. The interactive book or game assembly of claim 1 or 11, wherein the pages are puzzle pieces, each of the puzzle pieces having male and female ends that are capable of being operatively connected with at least one other puzzle piece to create a story, and wherein the pages can be physically connected in a variety of different storylines by attaching the pages together.

16. A method of rearranging pages of an interactive book or game assembly wherein:
placing a first page depicting a subject at the beginning of a sequence starts a story;
selecting a series of story pages depicting a noun, which may include an indefinite article are arranged or shuffled in any desired order following the first page;
following the story pages is a last page depicting a direct object, which follows the selected story pages concluding the story; and
shuffling, rearranging, or reorganizing the story pages to create a variety of new stories each time the story pages are moved.

17. The interactive book or game assembly of claim 1, 15 or 16, wherein the pages are made of silk, cloth, felt, cotton, paper, paperboard, cardboard, plastic, or another suitable material for printing text and illustrations on.

18. The method of claim 16 wherein the user selects one or more story pages to place in a sequence between the first page and the last page.

19. The method of claim 16 wherein the first page, the last page, or the story pages contain one or more apertures on one end to selectively bind the pages if a user chooses to keep the pages in a sequence or arrangement.

20. The method of claim 16 wherein the first page, the last page, and/or the story pages contain a magnetic edge on at least one side that corresponds to a magnetic section on a receptacle to selectively bind the pages if a user chooses.
